(19) United States
(12) Patent Application Publication
(10) Pub. No.: US 2011/0255971 A1
(43) Pub. Date: Oct. 20, 2011

(54) APPARATUS FOR OSCILLATING A FOIL IN A FLUID

(75) Inventors: Bas Goris, BC Rotterdam (NL); Gerard Petersen, Vijfhuizen (NL)

(73) Assignee: Bas Goris DBA Oscillating Foul Development

(21) Appl. No.: 13/059,910

(22) PCT Filed: Aug. 18, 2009
(86) PCT No.: PCT/NL09/00160

§ 371 Date: May 16, 2011

(30) Foreign Application Priority Data
Aug. 18, 2008 (NL) 1035842

(51) Int. Cl. B63H 1/36; B63H 23/02; F16H 21/40; F03B 17/06

(52) U.S. Cl. 416/79; 416/170 R

(57) ABSTRACT

The invention relates to an apparatus for oscillating a foil in a fluid. The apparatus according to the invention comprises a first crank mechanism and a second crank mechanism connected to a foil. Said first crank mechanism and said second crank mechanism have different crank pin offsets, are functionally connected such that when driven the speed of revolution of said first crank mechanism is the same as the speed of revolution of said second crank mechanism, and are out of phase with each other.

The invention relates to an apparatus for oscillating a foil in a fluid.

Oscillating or flapping foils were inspired by the nature of marine swimmers such as the tuna fish, shark, dolphin and whale. Marine swimmers use the combined effects of lift by vortices and lift by attached flow over a curved wing. Current industrial oscillating foils works with the principle of an attached flow over a curved wing. The lift is generated when the foil has an angle with the incoming flow of a medium. The lift is defined as the component of force acting in the plane of symmetry in the direction perpendicular to the incoming medium.

The apparatus according to the invention comprises:
a first crank mechanism having a first crankshaft rotatable about a first axis of rotation and having a first crank pin offset relative to the first axis of rotation;
a second crank mechanism having a second crankshaft rotatable about a second axis of rotation and having a second crank pin offset relative to the second axis of rotation;
a first connecting structure which is with one end rotatable connected to said first crank pin about a third axis of rotation and with another end rotatable connected to said foil about a fourth axis of rotation;
a second connecting structure which is with one end rotatable connected to said second crank pin about a fifth axis of rotation and with another end rotatable connected to said foil about a sixth axis of rotation; and
a guiding structure for guiding the oscillating movement of said foil;
   wherein
said first connecting structure and said second connecting structure extend in an inclined direction relative to the chord line of said foil;
said sixth axis of rotation is spaced apart from said fourth axis of rotation in the direction of the chord line of said foil;
the second crank pin offset is different from the first crank offset;
said first crank mechanism and said second crank mechanism are functionally connected such that when driven the speed of revolution of said first crank mechanism about said first axis of rotation is the same as the speed of revolution of said second crank mechanism about said second axis of rotation; and
said first crank mechanism and said second crank mechanism are out of phase with each other.

These features make it possible to provide a simple and robust mechanism with which a sinusoidal like heave and pitch motion of a foil can be achieved with large maximum pitch angles.

With an oscillating foil, both pitch and heave motions of the foil member need to be controlled, periodically and precisely, to produce the maximum possible efficiency and thrust. The design of currently known apparatuses for oscillating a foil in a fluid was aimed at describing a pure sinus shaped motion of both pitch and heave resulting in a sinus shape motion of the Angle of Attack as known from theoretical models. This resulted in apparatuses making use of complicated mechanisms for oscillating the foil that prove to be very defective and thus not suited well for industrial use.

The two crank mechanisms used in the apparatus according to the invention make for a simple and robust mechanism to transform a rotation into a sinusoidal like heave and pitch motion of the foil or vice versa. The feature of said first crank mechanism and said second crank mechanism being functionally connected such that when driven the speed of revolution of said first crank mechanism about said first axis of rotation is the same as the speed of revolution of said second crank mechanism about said second axis of rotation, can be realised with a simple and robust transmission and makes it possible that the pitch and heave motions of the foil member can be precise and periodic, while the combination of the feature that the second crank pin offset is different from the first crank offset and the feature that said first crank mechanism and said second crank mechanism are out of phase with each other, make it possible to precisely set the heave and pitch motion of the foil as well as the maximum occurring pitch of the foil. Thus the apparatus according to the invention provides a simple and robust alternative for the known complicated and defective apparatuses for oscillating a foil, while being able to achieve a sinusoidal like heave and pitch motion of the foil that approaches the pure sinus shaped motion of both pitch and heave resulting in great efficiency and thrust.

The apparatus according to the invention is especially suited for so called horizontally positioned foils.

Most known apparatuses for oscillating a foil for use of propulsion or renewable energy have the foil(s) vertically or horizontally positioned. Vertically placement of the foil has the disadvantage that this direction can be limited, like limited water depth or limited draught of a vessel, where horizontal positioning is less restricted, e.g. river streams or inland vessel are wide with a shallow depth/draught. Therefore horizontal positioned foils can be designed with a larger span resulting in low thrust loading and high efficiencies. The heave motion should be made as large as possible. A larger heave motion results in a relative larger effective stroke. The oscillating motion has preferably to follow a straight line perpendicular to the incoming flow, but full or partial circular motions are used as well. A disadvantage of full circular motion is the component in the direction of the flow resulting in a high relative flow to the foil if the foil moves toward the incoming flow and a lower relative flow if the foil moves with the incoming flow. This requires a complicated pitch adjustment, or a reduced rotation speed to avoid downwash (beyond the stall angle) of the foil during some part of the circular motion and thus a lower average power or efficiency loss.

The two crank mechanisms used in the apparatus according to the invention make it possible to provide large heave motion of a so called horizontally positioned foil along a substantially straight line perpendicular to the incoming flow, thus achieving great efficiency and thrust relative to known apparatuses having either horizontally positioned or vertically positioned foils.

In a preferred embodiment of the apparatus according to the invention with the first crank mechanism in a position in which the fourth axis of rotation is at one end of its stroke, the chord line of said foil is substantially perpendicular to a first line intersecting said first axis of rotation and said third axis of rotation, and the phase offset θ of the second crack mechanism relative to the first crank mechanism in the direction of rotation of the second crank mechanism equals:

θ=arccos(l₁/l₂),

in which l₁ is the first crank pin offset and l₂ is the second crank pin offset. This feature makes it possible that the apparatus in use provides for the chord line of the foil being substantially parallel to the flow both near the top and bottom of the stroke of the foil. Having the chord line of the foil substantially parallel to the flow both near the top and bottom of the stroke of the foil decreases the drag-resistance during this position.

In a preferred embodiment thereof the guiding structure is designed such that with the first crank mechanism in said position in which the fourth axis of rotation is at one end of its stroke, said first line intersects said third axis of rotation. This feature makes it possible to reduce the difference in motion of the foil between the upstroke and the down stroke.

In a further embodiment of the invention thereof the distance between said first axis of rotation and said second axis of rotation in the direction perpendicular to said first line is substantially equal to the distance between said fourth axis of rotation and said sixth axis of rotation in the direction of said chord-line. This feature makes it possible to reduce the difference in motion of the foil between the upstroke and the down stroke.

In a preferred embodiment thereof the distance between said first axis of rotation and said second axis of rotation in the direction of said first line equals zero. This feature makes it possible to provide for a reduced in-built height of the apparatus according to the invention.

In a further embodiment of the apparatus according to the invention said foil is rotatable connected to said guiding structure about a seventh axis of rotation. This feature makes it possible to provide for a simple and robust guiding of translation movement of the foil while not restricting the rotational movement of the foil, thus promoting the separation of the pitch motion of the foil and the guidance of the heave motion of the foil and therewith promoting the control over the pitch motion and the heave motion of the foil.

In a preferred embodiment thereof the guiding structure comprises a third connecting structure which is with one end rotatable connected to said foil about said seventh axis of rotation and with another end rotatable connected with a stationary point. This feature makes it possible to provide for a simple and robust embodiment of the guiding structure.

In a preferred embodiment thereof said third connecting structure is a parallelogram structure. This feature makes it possible to distribute the forces in the third connecting structure over more than one rod.

In a preferred embodiment of the apparatus according to the invention in which said foil is rotatable connected to said guiding structure about an seventh axis of rotation said seventh axis of rotation coincides with said fourth axis of rotation. This feature makes it possible to further promote the separation of the pitch motion of the foil and the guidance of the heave motion of the foil, thus promoting the control over the pitch motion and heave motion of the foil.

In a further embodiment of the apparatus according to the invention said first axis of rotation and said second axis of rotation coincide. This feature make is possible to use a single crankshaft, thus further simplifying the apparatus according to the invention.

In another further embodiment of the apparatus according to the invention said first crank mechanism and said second crank mechanism are functionally connected such that when driven the first crank mechanism and the second crank mechanism have the same direction of rotation. This feature makes it possible to functionally connect the first crank mechanism and the second crank mechanism in a simple and robust way by using for instance a belt or a chain.

In an alternative embodiment of the apparatus according to the invention said first crank mechanism and said second crank mechanism are functionally connected such that when driven the first crank mechanism and the second crank mechanism have a different direction of rotation. This feature makes it possible to functionally connect the first crank mechanism and the second crank mechanism in a simple and robust way by using for instance two gears of the same diameter.

In another embodiment of the apparatus according to the invention at least one of said first, second and third connecting structures is formed by a respective connecting rod. This feature makes it possible to provide for a simple and robust realization of each of the first, second and third connecting structure. In a preferred embodiment thereof the first connecting structure, the second connecting structure and the third connecting structure are formed by a respective connecting rod.

In a further embodiment of the apparatus according to the invention more than one foil is connected with said first crank mechanism and said second crank mechanism by said first connecting structure and said second connecting structure. This feature makes it possible to increase the output of the apparatus.

In a further embodiment of the apparatus according to the invention said first connecting structure and said second connecting structure are connected to said foil via a fourth connecting structure, said fourth connecting structure being a parallelogram structure such that a second line through said fourth axis of rotation and said sixth axis of rotation is parallel to the cord line of said foil through out the oscillating movement of said foil. This feature makes it possible to provide for a streamlined extension to the first connecting structure and the second connecting structure that can be placed in the fluid, thus promoting the reduction of the resistance of the part of the apparatus that is in use located in the fluid.

In another embodiment of the apparatus according to the invention said foil is designed such that it is flexible along the chord line thereof. This feature makes it possible to provide for a higher efficiency and a lower lift force. In an alternative or additional embodiment said foil is designed such that it is bendable along the span thereof. This feature makes it possible to provide for a higher efficiency and a lower lift force.

In another embodiment of the apparatus according to the invention the apparatus comprises a drive for driving at least one of the first crank mechanism and the second crank mechanism. This feature makes it possible to use the apparatus according to the invention to for instance propel a vessel or to generate a whirl or flow in a fluid.

In an alternative embodiment the apparatus according to the invention comprises a power generator functionally connected to at least one of the first crank mechanism and the second crank mechanism. This feature makes it possible to use the apparatus according to the invention for generating power from a fluid flow.

The invention further relates to a vessel comprising a hull, and an apparatus according to the invention having a drive for driving at least one of the first crank mechanism and the second crank mechanism, wherein at least said foil is located outside said hull.

The invention further relates to an installation for generating energy from a flow of fluid, such as water in a river, comprising an apparatus according to the invention having a power generator functionally connected to at least one of the first crank mechanism and the second crank mechanism, wherein at least said foil is located in said flow of fluid.

The invention further relates to an installation for generating a flow or whirl in a fluid, such as a mixer or a pump, comprising an apparatus according to the invention having a drive for driving at least one of the first crank mechanism and the second crank mechanism, wherein at least said foil is located in the fluid in which said flow or whirl is to be generated.

The invention further relates to an installation, comprising at least two functionally connected apparatuses according to the invention, wherein said apparatus are out of phase with each other. This feature makes it possible to achieve a more smoothed flow downstream of the foil and a more smoothed torque at the drive or generator.

The present invention will be further elucidated hereinbelow on the basis of exemplary embodiments, which are shown schematically in the accompanying figures. These are non limitative exemplary embodiments. In the figures features with the same reference sign are the same. In the figures:

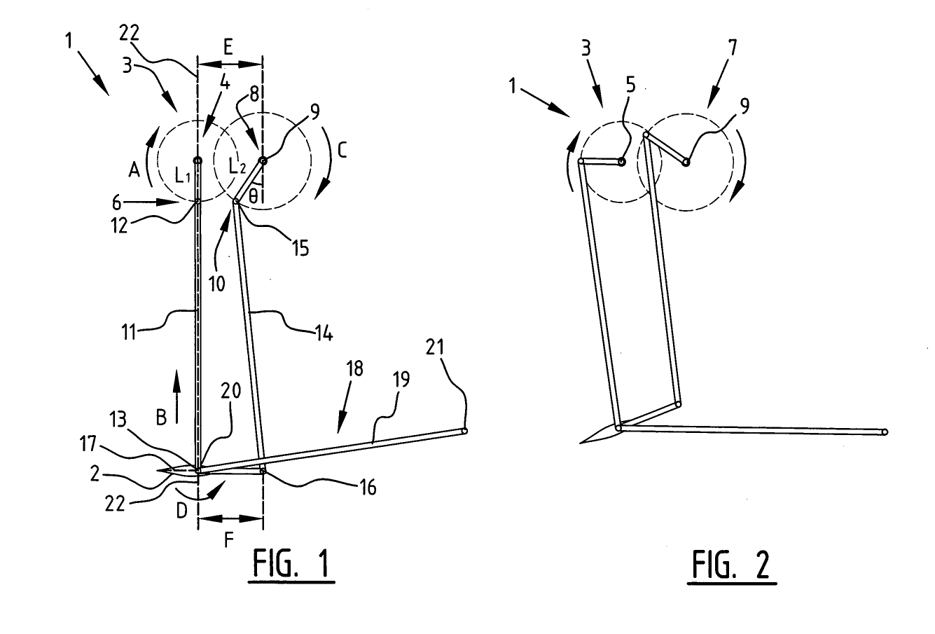

FIGS. 1 to 4 shows a schematic representation of an embodiment of the apparatus according to the invention;

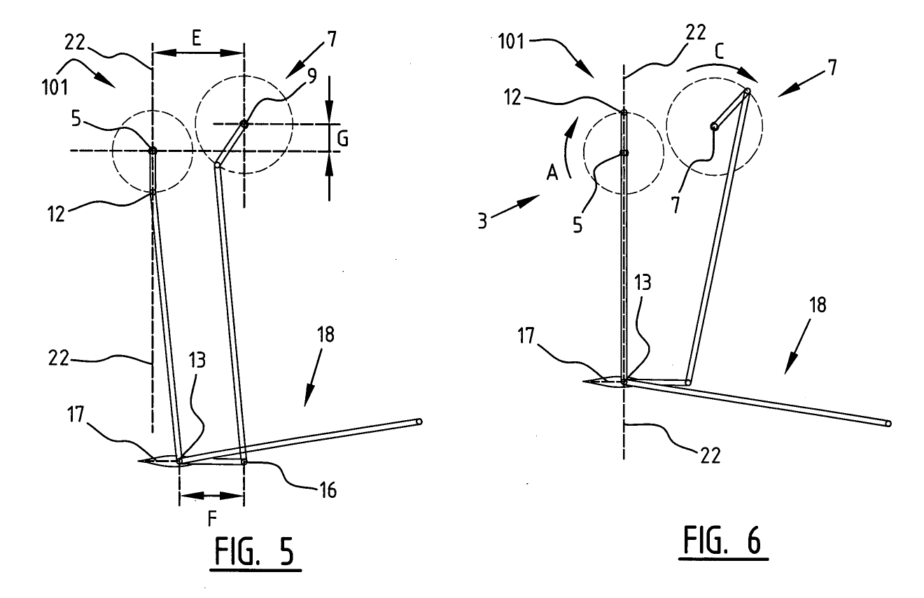

FIGS. 5 and 6 show a schematic representation of an alternative embodiment of the apparatus of FIG. 1;

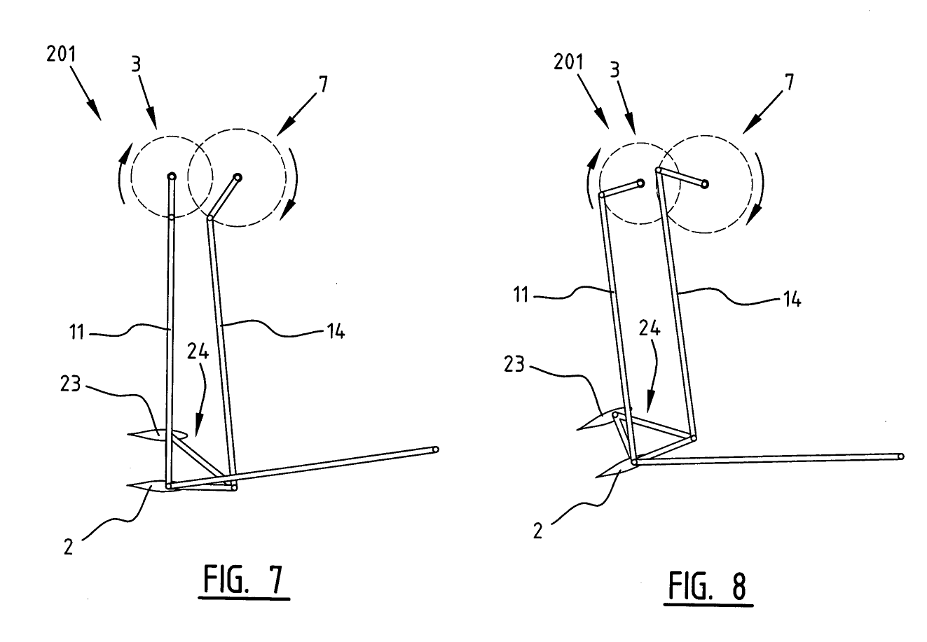

FIGS. 7 and 8 show a schematic representation of a further alternative embodiment of the apparatus of FIG. 1;

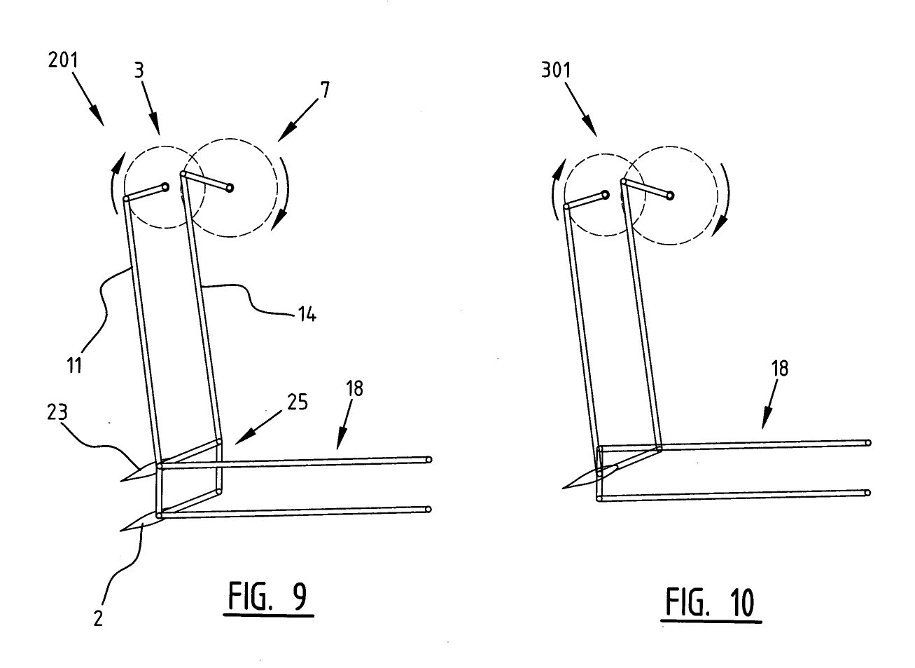

FIG. 9 shows an alternative embodiment of the apparatus of FIGS. 8 and 9;

FIG. 10 shows a schematic representation of a further alternative embodiment of the apparatus of FIG. 1;

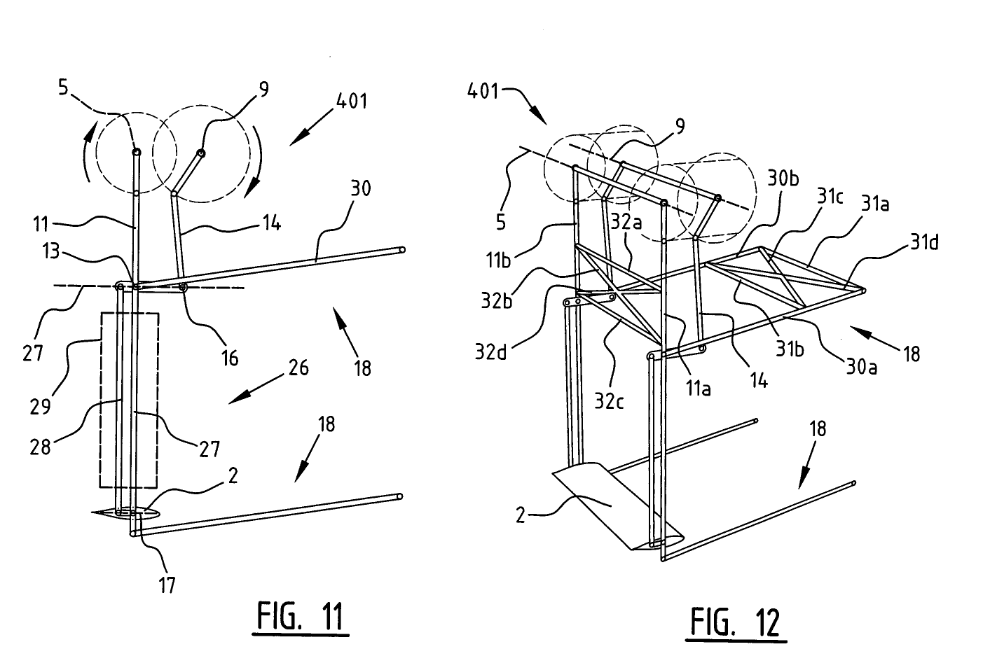

FIGS. 11 and 12 show a schematic representation of a further alternative embodiment of the apparatus of FIG. 1;

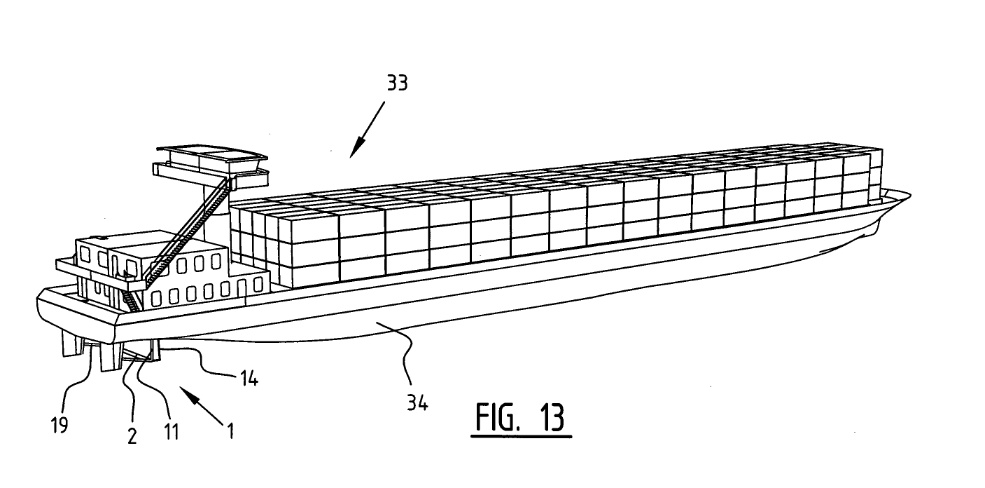

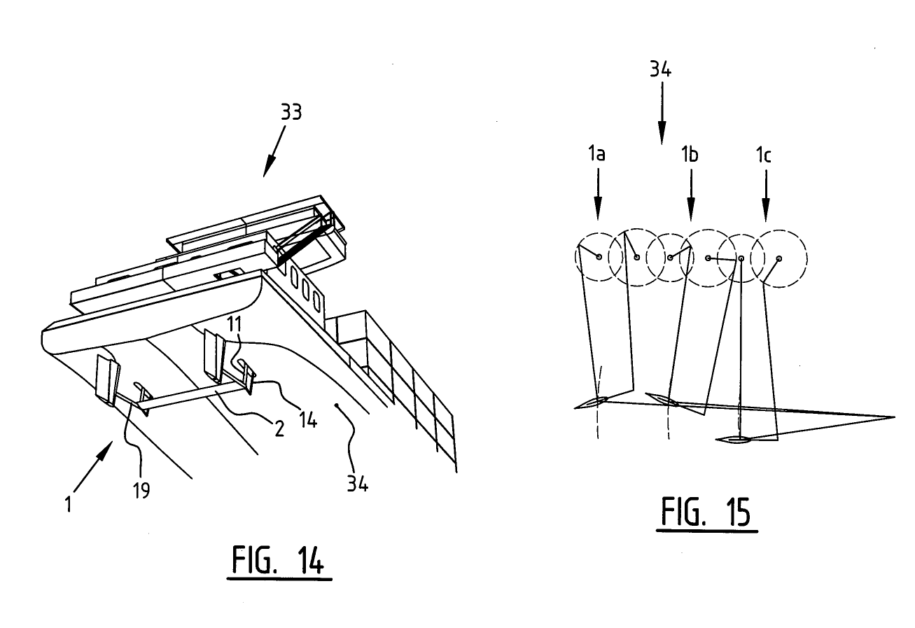

FIGS. 13 and 14 show a vessel with a hull and the apparatus 1 of FIG. 1;

FIG. 15 shows an installation having three apparatuses of FIG. 1;

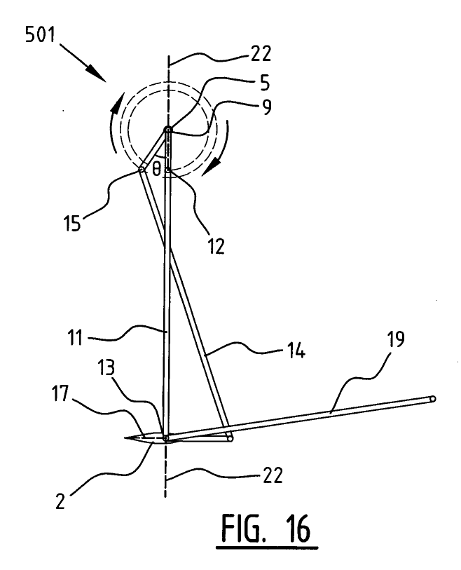

FIG. 16 shows a schematic representation of a further alternative embodiment of the apparatus of FIG. 1.

FIG. 1 shows an embodiment of the apparatus 1 for oscillating a foil 2 in a fluid according to the invention. The apparatus 1 is shown with a first crank mechanism 3 having a first crankshaft 4 rotatable about a first axis of rotation 5 and having a first crank pin 6 offset relative to said first axis of rotation. The apparatus 1 is further shown with a second crank mechanism 7 having a second crankshaft 8 rotatable about a second axis of rotation 9 and having a second crank pin 10 offset relative to said second axis of rotation. A first connecting rod 11, being the first connecting structure, is with one end rotatable connected to said first crank pin about a third axis of rotation 12 and with another end rotatable connected to said foil about a fourth axis of rotation 13. A second connecting rod 14, being the second connecting structure, is with one end rotatable connected to said second crank pin about a fifth axis of rotation 15 and with another end rotatable connected to said foil about a sixth axis of rotation 16. Both said first connecting structure and said second connecting structure extend in an inclined direction relative to the chord line 17 of said foil.

A guiding structure 18 is provided for guiding the oscillating movement of said foil. The guiding structure 18 is embodied as a third connecting structure. The third connecting structure is formed by a third connecting rod 19 which is with one end rotatable connected to said foil about a seventh axis of rotation 20 and with another end rotatable connected with a point 21 that is stationary relative to said first axis of rotation 5. Said seventh axis of rotation 20 coincides with said fourth axis of rotation 13. In use the guiding structure 18 is required to keep the foil oscillating substantially perpendicular to the incoming flow and to transfer the forces in the direction of that guiding structure 18 into the point 21.

A rotation of the first crank mechanism 3 about the first axis of rotation 5 in the direction of arrow A would result under guidance of the third connecting rod 19 in a translation of the foil 2 in the direction of arrow B, thus inducing a heave motion of the foil 2.

Further shown in FIG. 1 is that said sixth axis of rotation 16 is spaced apart from said fourth axis of rotation 13 in the direction of the chord line 17 of said foil. As a result thereof a rotation of the second crank mechanism 7 about the second axis of rotation 9 in the direction of arrow C would result in a rotation of the foil 2 about the fourth axis of rotation 13 in the direction of arrow D, thus inducing a pitch motion of the foil 2.

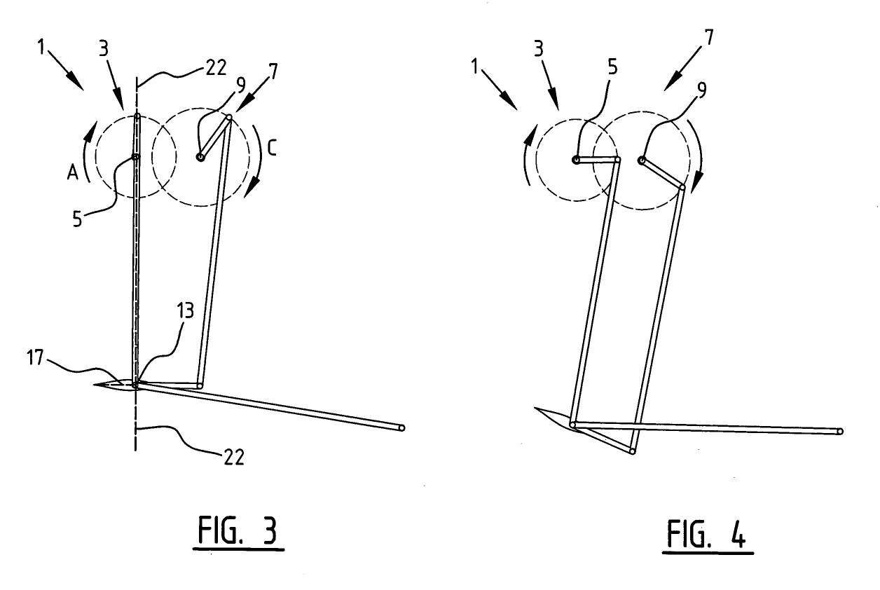

A rotation of the first crank mechanism 3 about the first axis of rotation 5 in the direction of arrow A together with a rotation of the second crank mechanism 7 about the second axis of rotation 9 in the direction of arrow C will induce a simultaneous heave motion and pitch motion of said foil 2, as is shown in FIGS. 2 to 4. In FIGS. 2 to 4 the apparatus of FIG. 1 is shown with both the first crank mechanism 3 and the second crank mechanism 7 rotated about the first axis of rotation 5 and the second axis of rotation 9 respectively, over 90° (FIG. 2), 180° (FIG. 3) and 270° (FIG. 4) respectively, relative to the apparatus in the position as shown in FIG. 1.

In FIG. 1 the first crank mechanism 3 is in a position in which the fourth axis of rotation 13 is at one end, that is the bottom end, of its stroke. In the shown position the chord line 17 of said foil is substantially perpendicular to a first line 22 intersecting said first axis of rotation 5 and said third axis of rotation 12. The guiding structure is designed such that said first line 22 also intersects said fourth axis of rotation 13.

The distance E between said first axis of rotation 5 and said second axis of rotation 9 in the direction perpendicular to said first line 22 is substantially equal to the distance F between said fourth axis of rotation 13 and said sixth axis of rotation 16 in the direction of said chord-line 17.

The first crank mechanism 3 and said second crank mechanism 7 are out of phase with each other. The phase offset θ of the second crack mechanism 7 relative to the first crank mechanism 3 in the direction of rotation of the second crank mechanism C equals:

θ=arccos(l₁/l₂),

in which l₁ is the first crank pin offset and l₂ is the second crank pin offset. Together with the second crank pin offset l₂ being different from the first crank pin offset l₁, with this phase offset θ is achieved, that both in the bottom end (FIG. 1), and in the top end (FIG. 4), of the stroke of the fourth axis of rotation 13, the chord line 17 of said foil 2 is substantially perpendicular to the first line 22 intersecting said first axis of rotation 5 and said third axis of rotation 12, when said first crank mechanism 3 and said second crank mechanism 7 are rotated in the direction of arrow A and arrow C respectively with the same speed of revolution.

FIGS. 5 and 6 show an alternative embodiment of the apparatus 1 of FIG. 1, in which apparatus 101 the guiding structure 18 is designed such that with the first crank mechanism 3 in said position in which the fourth axis of rotation 13 is at one end of its stroke, said first line 22 does not intersect said fourth axis of rotation 13. Also in the apparatus 101 the distance E between said first axis of rotation 5 and said second axis of rotation 9 in the direction perpendicular to said first line 22 is different from the distance F between said fourth axis of rotation 13 and said sixth axis of rotation 16 in the direction of said chord-line 17. Further in the apparatus 101 there is a distance G between said first axis of rotation 5 and said second axis of rotation 9 in the direction of said first line 22 greater than zero. Further apparatus 101 equals apparatus 1 of FIG. 1 such that both in the bottom end (FIG. 5), and in the top end (FIG. 6), of the stroke of the fourth axis of rotation 13, the chord line 17 of said foil 2 is substantially perpendicular to the first line 22 intersecting said first axis of rotation 5 and said third axis of rotation 12, when said first crank mechanism 3 and said second crank mechanism 7 are rotated in the direction of arrow A and arrow C respectively with the same speed of revolution.

FIGS. 7 and 8 show a further alternative embodiment of the apparatus 1 of FIG. 1, in which apparatus 201 apart from the first foil 2 a second foil 23 is connected with said first crank mechanism 3 and said second crank mechanism 7 by said first connecting rod 11 and said second connecting rod 14. The second foil 23 is connected rigidly to said first foil 2 by a triangle structure 24, such that in use the movement of the second foil 23 equals the movement of the first foil 2.

FIG. 9 shows an alternative for the triangle structure of FIGS. 7 and 8. In FIG. 9 the movement of the second foil 23 is coupled to the movement of the first foil 2 by use of a parallelogram structure 25. This requires the guiding structure 18 to be a parallelogram structure too.

FIG. 10 shows another alternative embodiment of the apparatus 1 of FIG. 1, in which apparatus 301 the guiding structure 18 is formed by a parallelogram structure.

FIGS. 11 and 12 show another alternative embodiment of the apparatus 1 of FIG. 1. In the apparatus 401 the first connecting rod 11 and said second connecting rod 14 are connected to said foil 2 via a fourth connecting structure 26. Said fourth connecting structure 26 is a parallelogram structure such that a second line 27 through said fourth axis of rotation 13 and said sixth axis of rotation 16 is parallel to the cord line 17 of said foil 2 through out the oscillating movement of said foil 2. This requires the guiding structure 18 to be a parallelogram structure too. The connecting rods 27 and 28 of the connecting structure 26 are located relatively close to each other, making it possible to build a streamlined enclosure 29 around said connecting rods 27 and 28 to reduce the resistance of said connecting structure 26 in the fluid.

FIG. 12 shows the apparatus 401 in perspective. Shown in FIG. 12 is that between the two upper connecting rods 30a and 30b of the guiding structure 18 strengthening rods 31a to 31d are arranged in a triangular configuration for strengthening the guiding structure 18. Also between the two connecting rods 11a and 11b of the first connecting structure strengthening rods 32a to 32d are arranged in a triangular configuration for strengthening said first connecting structure.

FIGS. 13 and 14 show a vessel 33 with a hull 34 and the apparatus 1 of FIG. 1, wherein the foil 2 is located outside said hull 34 and the first crank mechanism and the second crank mechanism are located inside the hull 34. The apparatus 1 is inside the hull provided with a drive for driving at least one of the first crank and the second crank, such that the apparatus 1 functions as a propulsion for the vessel 33.

FIG. 15 shows an installation 34 with three apparatuses 1a, 1b, 1c of FIG. 1 that are functionally connected such that a rotation of a crank mechanism of one of the apparatuses induces a rotation of both crank mechanisms of the other apparatuses. As shown the apparatuses 1a, 1b and 1c are out of phase with each other.

FIG. 16 shows an alternative embodiment of the apparatus 1 of FIG. 1. In the apparatus 501 said first axis of rotation 5 and said second axis of rotation 9 coincide. This has the advantage that the same crankshaft 35 can be used for both crank mechanisms. The disadvantage however is that it is not possible to have the chord line 17 of the foil 2 both top and bottom of the stroke of the fourth axis of rotation 13, perpendicular to the first line 22 intersecting said first axis of rotation 5 and said third axis of rotation 12. The design however can be made such that the chord line of the foil is perpendicular to the first line 22 close to the top or bottom of the stroke of the fourth axis of rotation 13.

The first connecting rod can also be referred to as ‘power rod’. The second connecting rod can also be referred to as ‘pitch adjusting rod’. The third connecting rod can also be referred to as ‘kite rod’.

In the figures the point 21 and the guiding structure 18 are located on the right side of the foil 2. The point 21 and the guiding structure could also be located on the left side of the guiding structure.

In the figures the guiding structure 18 is formed as a connecting structure. The guide structure could for instance also be formed as a rail structure extending parallel to the first line 22.

In the figures the first crank mechanism and the second crank mechanism are rotated in the same direction. Said first crank mechanism and said second crank mechanism could also be functionally connected such that when driven the first crank mechanism and the second crank mechanism have a different direction of rotation.

In the figures the foil has a symmetrical foil shape, but it could take other forms while still acting as a lifting surface, including a simple flat plate, a foil with an active tail flap or an eye shaped profile.

1. Apparatus for oscillating a foil in a fluid, comprising
a first crank mechanism having a first crankshaft rotatable about a first axis of rotation and having a first crank pin offset relative to the first axis of rotation;
a second crank mechanism having a second crankshaft rotatable about a second axis of rotation and having a second crank pin offset relative to the second axis of rotation;
a first connecting structure which is with one end rotatable connected to said first crank pin about a third axis of rotation and with another end rotatable connected to said foil about a fourth axis of rotation;
a second connecting structure which is with one end rotatable connected to said second crank pin about a fifth axis of rotation and with another end rotatable connected to said foil about a sixth axis of rotation; and
a guiding structure for guiding the oscillating movement of said foil; wherein
said first connecting structure and said second connecting structure extend in an inclined direction relative to the chord line of said foil;
said sixth axis of rotation is spaced apart from said fourth axis of rotation in the direction of the chord line of said foil;
the second crank pin offset is different from the first crank offset;
said first crank mechanism and said second crank mechanism are functionally connected such that when driven the speed of revolution of said first crank mechanism about said first axis of rotation is the same as the speed of revolution of said second crank mechanism about said second axis of rotation; and
said first crank mechanism and said second crank mechanism are out of phase with each other;
wherein with the first crank mechanism in a position in which the fourth axis of rotation is at one end of its stroke:
the chord line of said foil is substantially perpendicular to a first line intersecting said first axis of rotation and said third axis of rotation, and
the phase offset θ of the second crack mechanism relative to the first crank mechanism in the direction of rotation of the second crank mechanism equals:
θ=arccos(l₁/l₂),
in which l₁ is the first crank pin offset and l₂ is the second crank pin offset.

2. (canceled)

3. Apparatus according to claim 1, wherein the guiding structure is designed such that with the first crank mechanism in said position in which the fourth axis of rotation is at one end of its stroke, said first line intersects said fourth axis of rotation.

4. Apparatus according to claim 1, wherein the distance between said first axis of rotation and said second axis of rotation in the direction perpendicular to said first line is substantially equal to the distance between said fourth axis of rotation and said sixth axis of rotation in the direction of said chord-line.

5. Apparatus according to claim 1, wherein the distance between said first axis of rotation and said second axis of rotation in the direction of said line equals zero.

6. Apparatus according to claim 1, wherein said foil is rotatable connected to said guiding structure about a seventh axis of rotation.

7. Apparatus according to claim 6, wherein the guiding structure comprises a third connecting structure which is with one end rotatable connected to said foil about said seventh axis of rotation and with another end rotatable connected with a point stationary relative to said first axis of rotation.

8. Apparatus according to claim 7, wherein said third connecting structure is a parallelogram structure.

9. Apparatus according to claim 6, wherein said seventh axis of rotation coincides with said fourth axis of rotation.

10. Apparatus according to claim 1, wherein said first axis of rotation and said second axis of rotation coincide.

11. Apparatus according to claim 1, wherein said first crank and said second crank are functionally connected such that when driven the first crank and the second crank have the same direction of rotation.

12. Apparatus according to claim 1, wherein said first crank and said second crank are functionally connected such that when driven the first crank and the second crank have a different direction of rotation.

13. Apparatus according to claim 1, wherein at least one of the first, second and third connecting structures is formed by a respective connecting rod.

14. Apparatus according to claim 1, wherein the first connecting structure, the second connecting structure and the third connecting structure are formed by a respective connecting rod.

15. Apparatus according to claim 1, wherein more than one foil is connected with said first crank mechanism and said second crank mechanism by said first connecting structure and said second connecting structure.

16. Apparatus according to claim 1, wherein said first connecting structure and said second connecting structure are connected to said foil via a fourth connecting structure, said fourth connecting structure being a parallelogram structure such that a second line through said fourth axis of rotation and said sixth axis of rotation is parallel to the cord line of said foil through out the oscillating movement of said foil.

17. Apparatus according to claim 1, wherein said foil is designed such that it is flexible along the chord line thereof.

18. Apparatus according to claim 1, wherein said foil is designed such that it is bendable along the span thereof.

19. Apparatus according to claim 1, comprising a drive for driving at least one of the first crank and the second crank.

20. Apparatus according to claim 1, further comprising a power generator functionally connected to at least one of the first crank and the second crank.

21. Vessel, comprising:
a hull; and
an apparatus according to claim 19, wherein at least said foil is located outside said hull.

22. Installation for generating energy from a flow of fluid, such as water in a river, comprising an apparatus according to claim 20, wherein at least said foil is located in said flow of fluid.

23. Installation for generating a flow or whirl in a fluid, comprising an apparatus according to claim 19, wherein at least said foil is located in the fluid in which said flow or whirl is to be generated.

24. Installation, comprising at least two functionally connected apparatuses according to claim 1, wherein said apparatuses are out of phase with each other.
